(19) United States
(12) Patent Application Publication
(10) Pub. No.: US 2009/0275283 A1
(43) Pub. Date: Nov. 5, 2009

(54) Use of intra-body communication

(76) Inventor: Zhao Zhuyan, Beijing (CN)

Correspondence Address: HARRINGTON & SMITH, PC, 4 RESEARCH DRIVE, Suite 202, SHELTON, CT, 06484-6212, US

(21) Appl. No.: 12/308,861

(22) PCT Filed: Aug. 29, 2006
(86) PCT No.: PCT/FI2006/050368

§ 371 Date: Dec. 23, 2008

(51) Int. Cl. H04B 7/00

(52) U.S. Cl. 455/41.2

(57) ABSTRACT

Disclosed is a communication apparatus capable of communicating with a radio network and capable of communicating with an external apparatus over an intra-body communication connection and an accessory apparatus capable of transmitting data to a radio network and capable of communicating with an external apparatus over an intra-body communication connection. The communication apparatus communicates through the intra-body communication connection to the accessory apparatus configuration data relating to connecting to the radio network.

### FIELD OF THE INVENTION

The present invention generally relates to communication systems and use of intra-body communication.

### BACKGROUND OF THE INVENTION

A personal area network (PAN) is a communication system that allows electronic devices on and near the human body to exchange digital information through short-range communication. Exemplary technologies suitable for establishing a PAN include Bluetooth and Ultra Wideband (UWB) technologies to name a few non-limiting examples of wireless short-range communication technologies and near-field electrostatic coupling, such as, for example RFID and intra-body communication. A wide area network (WAN) is a communication system that connects various computing or communication devices, which may be further apart from each other, using microwaves, radio waves, coaxial cable, and/or fiber optic.

Intra-body communication (IBC) is a communication technology that uses the human body as the transmission medium for electrical signals. Intra-body communication technology is a good candidate for personal area networks, since its weak electric-field transmission method has many merits: it is wireless(-like) communication, required power levels are low, the communication is secure (touch condition is needed for communication, whereby eavesdropping is unlikely to succeed) and it is license free (no frequency band is needed as radio waves are not used).

For example Masaaki Fukomoto et al., “A Broad-band Intra body Communication system with Electro-Optic Probe”, 1AD: First International Conference on Appliance Design 2003, discloses an example implementation of an intra-body communication system.

Actual applications of intra-body communication technology are however still under development. Hence, many details of such applications may still require further considerations.

### SUMMARY

According to a first aspect of the invention there is provided a communication apparatus comprising
a memory,
a processor coupled to the memory,
a receiver capable of receiving data from a radio network, and
an intra-body communication block capable of communicating data through a human body, when in contact with the human body,
wherein the processor is configured to control the intra-body communication block to establish an intra-body communication connection with an accessory apparatus and to control the communication apparatus to communicate through the intra-body communication connection configuration data relating to connecting to the radio network.

According to a second aspect of the invention there is provided an accessory apparatus comprising
a memory,
a processor coupled to the memory,
a transmitter capable of transmitting data to a radio network, and
an intra-body communication block capable of communicating data through a human body, when in contact with the human body,
wherein the processor is configured to control the intra-body communication block to communicate over an intra-body communication connection with a communication apparatus, and to control the accessory apparatus to receive through the intra-body communication connection configuration data relating to connecting to the radio network via the transmitter.

According to a third aspect of the invention there is provided a method in a communication apparatus capable of communicating with a radio network and capable of communicating with an external apparatus over an intra-body communication connection, the method comprising:
establishing an intra-body communication connection with an accessory apparatus; and
communicating through the intra-body communication connection configuration data relating to connecting to the radio network.

According to an embodiment of the invention an activation procedure is initiated through the intra-body communication connection for activating the accessory apparatus in response to activation of a radio connection between the communication apparatus and the radio network.

According to another embodiment of the invention an activation procedure is initiated through the intra-body communication connection for activating the accessory apparatus in response to being in contact with a human body.

According to an embodiment of the invention the configuration data, which is communicated through the intra-body communication connection, is received from the radio network.

According to an embodiment of the invention configuration data is communicated through the intra-body communication connection in response to receiving the configuration data from the radio network.

The configuration data, which is communicated through the intra-body communication connection, may be data that is needed for establishing and/or maintaining association to the radio network. For example, the configuration data, which is communicated through the intra-body communication connection, may comprise at least one of the following: base station information, scrambling code, information on spreading factor, synchronization information, transmission power, transmission time, and information on used frequency.

According to an embodiment of the invention payload data is transmitted to the radio network such that at least a portion of the payload data is communicated through the intra-body communication connection to the accessory apparatus for transmission to the radio network.

According to a further embodiment of the invention payload data is transmitted to the radio network such that a first part of the payload data is communicated through the intra-body communication connection to the accessory apparatus for transmission to the radio network, and a second part of the payload data is transmitted to the radio network through the transmitter directly from the communication apparatus.

According to a fourth aspect of the invention there is provided a method in an accessory apparatus capable of transmitting data to a radio network and capable of communicating with an external apparatus over an intra-body communication connection, the method comprising:
communicating over an intra-body communication connection with a communication apparatus; and
receiving through the intra-body communication connection configuration data relating to connecting to the radio network via the transmitter.

According to an embodiment of the invention an activation signal is received through the intra-body communication connection for activating the accessory apparatus and the accessory apparatus is activated in response to the activation signal.

The configuration data, which is received through the intra-body communication connection, may be data that is needed for establishing and/or maintaining association to the radio network. For example the configuration data, which is received through the intra-body communication connection, may comprise at least one of the following: base station information, scrambling code, information on spreading factor, synchronization information, transmission power, transmission time, and information on used frequency.

According to an embodiment of the invention data is transmitted to the radio network responsive to data communicated through the intra-body communication connection.

According to an embodiment of the invention payload data to be sent to the radio network is received through the intra-body communication connection and the payload data is sent to the radio network.

According to an embodiment of the invention the. accessory apparatus is configured to co-operate with the communication apparatus for establishing a diversity scheme for transmission of payload data from the communication apparatus to the radio network such that a first part of the payload data is communicated through the intra-body communication connection to the accessory apparatus for transmission to the radio network, and a second part of the payload data is transmitted to the radio network directly from the communication apparatus.

According to a sixth aspect of the invention there is provided a system communication apparatus and an accessory apparatus, wherein
the communication apparatus comprises
   a memory,
   a processor coupled to the memory,
   a receiver capable of receiving data from a radio network, and
   an intra-body communication block capable of communicating data through a human body, when in contact with the human body,
   wherein the processor of the communication apparatus is configured to control the intra-body communication block to establish an intra-body communication connection with the accessory apparatus and to control the communication apparatus to communicate through the intra-body communication connection configuration data relating to connecting to the radio network; and wherein
the accessory apparatus comprises
   a memory,
   a processor coupled to the memory,
   a transmitter capable of transmitting data to a radio network, and
   an intra-body communication block capable of communicating data through a human body, when in contact with the human body,
   wherein the processor of the accessory apparatus is configured to control the intra-body communication block to communicate over an intra-body communication connection with the communication apparatus, and to control the accessory apparatus to receive through the intra-body communication connection configuration data relating to connecting to the radio network via the transmitter.

The system may further comprise a radio network, the radio network being capable of communicating with the communication apparatus and the accessory apparatus at least through the receiver of the communication apparatus and the transmitter of the accessory apparatus.

According to a sixth aspect of the invention there is provided a computer program stored in a computer readable medium, the computer program comprising computer executable program code adapted to cause an apparatus to implement the third aspect.

According to a seventh aspect of the invention there is provided a computer program stored in a computer readable medium, the computer program comprising computer executable program code adapted to cause an apparatus to implement the fourth aspect.

According to an eighth aspect of the invention there is provided a communication apparatus capable of communicating with a radio network and capable of communicating with an external apparatus over an intra-body communication connection, the communication apparatus comprising:
means for establishing an intra-body communication connection with an accessory apparatus; and
means for communicating through the intra-body communication connection configuration data relating to connecting to the radio network.

According to a ninth aspect of the invention there is provided an accessory apparatus capable of transmitting data to a radio network and capable of communicating with an external apparatus over an intra-body communication connection, the accessory apparatus comprising:
means for communicating over an intra-body communication connection with a communication apparatus; and
means for receiving through the intra-body communication connection configuration data relating to connecting to the radio network via the transmitter.

Some embodiments according to the present invention in which transmitter of an accessory apparatus is used at least partially instead of a transmitter of a mobile station offer the advantage that power consumption in the mobile station can be decreased, whereby operating time of the mobile station can be increased. Additionally the distance between transmit antennas of the mobile phone and the accessory apparatus can be such that the correlation between the antennas is not high, whereby uplink transmission diversity schemes may be employed.

Some embodiments according to the present invention in which a mobile phone and an accessory apparatus are connected through Electro-Static Coupling (ESC) intra-body communication offer the advantage that low frequency and low power electrostatic field signal is used whereby the Specific Absorption Rate (SAR) generated by communication between the mobile station and the accessory apparatus is low.

Various embodiments of the present invention have been illustrated only with reference to certain aspects of the invention. It should be appreciated that corresponding embodiments may apply to other aspects as well.

### BRIEF DESCRIPTION OF THE DRAWINGS

The invention will be described, by way of example only, with reference to the accompanying drawings, in which:

FIG. 1 shows a flow diagram of a method according to an embodiment of the invention for use in a communication apparatus;

FIG. 2 shows a flow diagram of a method according to an embodiment of the invention for use in an accessory apparatus;

FIG. 3 shows an arrangement according to an embodiment of the invention;

FIG. 4 shows a system according to an embodiment of the invention;

FIG. 5 shows a block diagram of an intra-body communication module according to an embodiment of the invention;

FIG. 6A-6C show a mobile station according to an embodiment of the invention, and

FIG. 7 shows a messaging diagram according to an embodiment of the invention.

### DETAILED SPECIFICATION

Below the term communication apparatus or mobile station refers in general to a device having radio communication capabilities. Such device may be for example a GSM (Global System for Mobile communication) terminal, a 3G (third-generation) terminal, a UMTS (Universal Mobile Telecommunications Service) terminal, a WCDMA (Wideband Code-Division Multiple Access) terminal or a terminal using WLAN (Wireless Local Area Network) for radio communications.

In various embodiments of the invention a communication apparatus and an accessory apparatus communicate over Electro-Static Coupling (ESC) intra-body communication. The intra-body communication uses user's body as a data transport medium.

In an embodiment of the invention an accessory apparatus helps a communication apparatus, such as a mobile station, to transmit data to a wide area network or a radio network (to a base station or some other network element of the radio network). Network configuration data is communicated from the communication apparatus to the accessory apparatus using intra-body communication. The network configuration data is data that is needed to ensure that the accessory apparatus is capable of keeping the communication apparatus connected to the radio network. At least two modes of operation can be mentioned here: 1) relay mode and 2) diversity mode.
1) Relay mode: The accessory apparatus transmits to the radio network the signal the mobile station would normally transmit. The mobile station may shut down its own transmitter function and operate only as a receiver for receiving signal from the radio network. The transmission is conducted through the accessory apparatus. In this way the mobile station does not consume the power needed for operating an RF. transmitter. Only after the accessory apparatus runs out of power, the transmitter of the mobile station needs to be taken into use.
For a mobile station, the talk time supported by the battery is usually 1/10 of the standby time, since the power of a mobile station is mainly consumed by an RF transmitter. For people who talk a lot with their mobile stations the limited talk time of a mobile station may be a burden: they need to charge the phone often or even carry an extra battery with them. When the accessory apparatus is used as a transmitter for the mobile station, the power consumption of the phone can be reduced, whereby the talk time of the mobile station can be increased.
It should be appreciated that in the relay mode the mobile station could be implemented without having transmitter capabilities at all. In many cases the mobile station would however have normal transmission capabilities.
2) Diversity mode: A Multi input and Multi output (MIMO) arrangement where the accessory apparatus operates as an additional RF transmitter in addition to the mobile station is employed. That is, both the mobile station and the accessory apparatus transmit signal to the radio network. The accessory apparatus sends different signal than the mobile station. The signals transmitted form the mobile station and the accessory apparatus are combined in the radio network (e.g. in a base station or some other network element). In this case Tx diversity algorithms, such as STBC (Space-Time Block Code), STTC (Space-Time Trellis Code), Beam Forming and so forth, can be utilized.
The use of multiple antennas requires that the distance between the antennas is at least more than λ, which is more than 15 cm for 2 GHz, in order to reduce correlation between the antennas. Due to the physical size-limitations and dimensions of mobile stations such distance between multiple antennas may be difficult to realize within a mobile station. Whereas with the use of an accessory apparatus the distance between the antennas can easily be such that the correlation between the transmit antenna of the mobile station and the transmit antenna of the accessory apparatus is not high. For example more than 15 cm distance can be easily achieved.

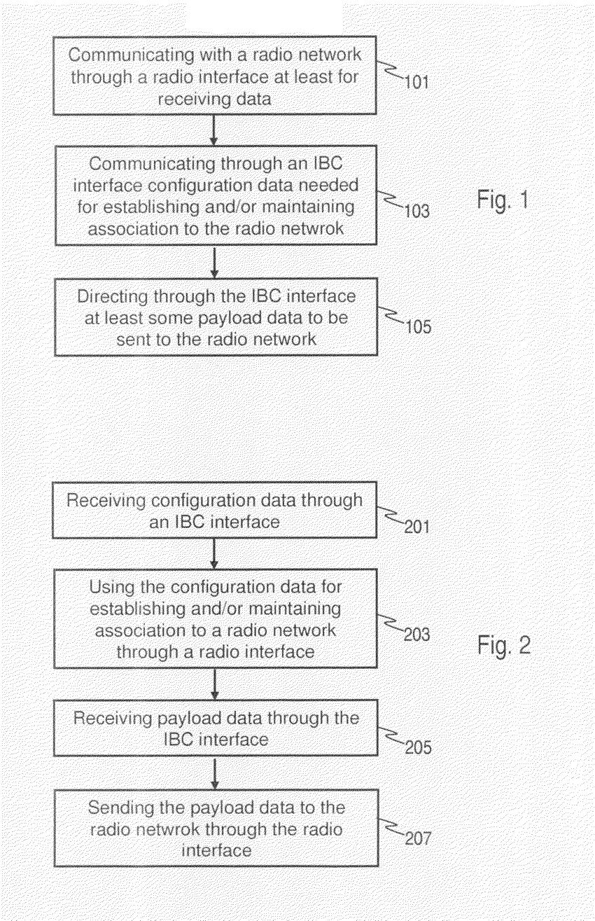

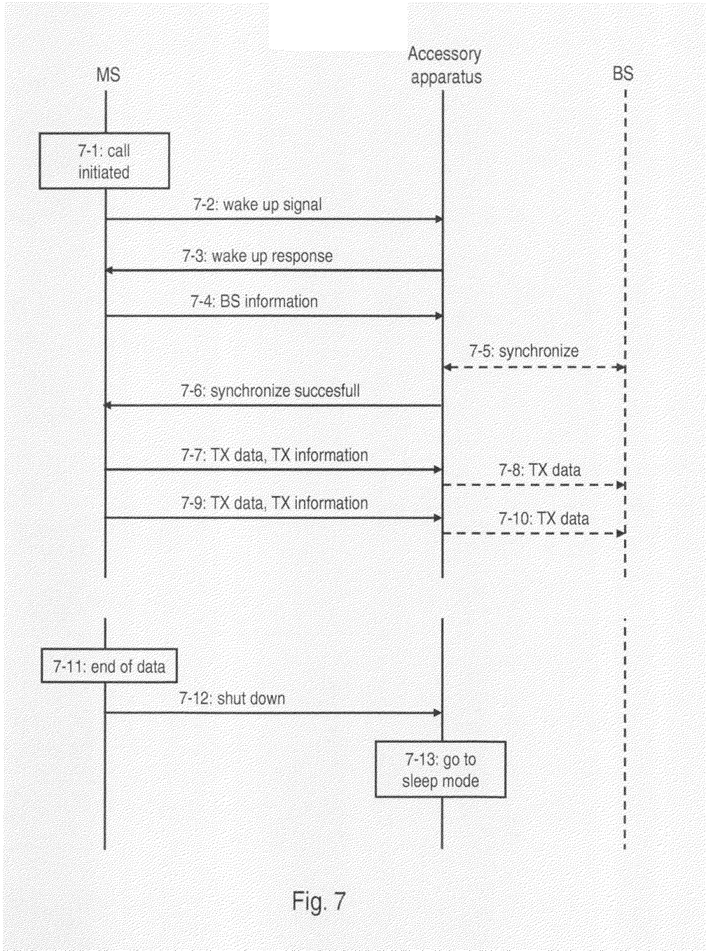

FIG. 1 shows a flow diagram of a method according to an embodiment of the invention for use in a communication apparatus. In phase 101, the communication apparatus communicates with a radio network (which is typically a wide area network) through a radio interface at least for receiving data. The communication apparatus may also transmit data through the radio interface, but it is not mandatory for implementation of the invention. In phase 103, the communication apparatus communicates through an IBC (intra-body communication) interface to an accessory apparatus configuration data needed for establishing and/or maintaining association to the radio network. This phase may comprise an initiation procedure for waking up the accessory apparatus. An example further illustrating such option is discussed in connection with FIG. 7. Once the accessory apparatus has an association to the radio network the communication apparatus directs, in phase 105, through the IBC interface at least some payload data to be sent to the radio network by the accessory apparatus.

FIG. 2 shows a flow diagram of a method according to an embodiment of the invention for use in an accessory apparatus. In phase 201, the accessory apparatus receives configuration data through an IBC interface. This phase may comprise an initiation procedure for waking up the accessory apparatus, if the accessory apparatus is initially in sleep mode. A further example illustration of such option is discussed in connection with FIG. 7. Then in phase 203, the accessory apparatus uses the configuration data for establishing and/or maintaining association to a radio network through a radio interface. This phase may include that the accessory apparatus acknowledges successful connection to the radio network (not shown). In phase 205, the accessory apparatus receives payload data through the IBC interface and in phase 207, the accessory apparatus sends the payload data to the radio network through the radio interface. The sending of the payload data may be conducted under the influence of the configuration data. Moreover additional configuration data may be received together with the payload data, that is, receiving the configuration data and the payload data do not need to be separate steps.

The configuration data that is communicated in flow diagrams of FIGS. 1 and 2 may comprise one or more of the following: base station information, scrambling code, information on spreading factor, synchronization information, transmission power, transmission time, and information on used frequency. The configuration data may concern communication in uplink or downlink direction or both. For example, if the radio network is a WCDMA network, the configuration data may comprise one or more of the following: downlink scrambling code used in a base station, downlink DPDCH (Dedicated Physical Data Channel) SF (Spreading Factor), downlink SF code, and downlink DPDCH frame transmission time. By using this information the accessory apparatus may synchronize with the BS the mobile station is using, and obtain uplink TX DPDCH time. For sending uplink data through the accessory apparatus, the configuration data in connection with a WCDMA network may comprise one or more of the following: transmission power (which may be set by a closed-loop power control), uplink scrambling code, uplink SF, and uplink SF code. Also TFCI (Transport Format Combination Indicator) of each TX frame may be included, if channel coding is carried out in the accessory apparatus. If diversity mode used, then the configuration data may include some parameters relating to different MIMO schemes. As an alternative example, if the radio network is a GSM network, the configuration data may comprise one or more of the following: the frequency that is used, transmission slot, and transmission power.

It should be appreciated that the phases illustrated in FIGS. 1 and 2 may be conducted out of order and repeated as many times as necessary. For example, a communication apparatus may repeatedly receive from the radio network configuration information relating to maintaining association to the radio network and the communication apparatus may be configured to repeatedly communicate the configuration data to the accessory apparatus as a response to receiving the configuration data.

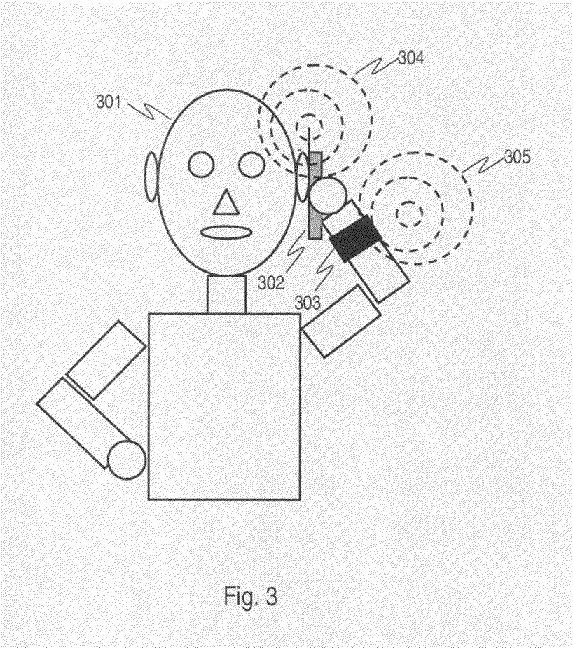

FIG. 3 shows an arrangement according to an embodiment of the invention. A person 301 uses a mobile station 302. The mobile station utilizes an accessory apparatus 303 implemented in a wrist watch for transmission of data to a radio network. The mobile station and the accessory apparatus communicate with each other through an intra-body communication connection. From FIG. 3 it can be seen that the distance between the mobile station and the accessory apparatus is such that correlation between the electromagnetic fields 305 and 306 of the transmit signals from them is not high, whereby the transmitters of the mobile station and the accessory apparatus can be used in diversity mode discussed above. Equally the relay mode discussed above can be used in the shown arrangement.

In addition to a wrist watch, other suitable objects in which an accessory apparatus of various embodiments of the invention can be implemented include any wearable or portable object, that is in substantial contact with human body. Direct skin connection may be provided but is not a requisite. Instead the object comprising the accessory apparatus may be isolated from the human body for example by cloth. Examples of suitable objects include jewelry (necklace, bracelet etc.), clothing, a cap or a hat, eyeglasses and so forth. A benefit allowed by some embodiments of the invention wherein the accessory apparatus is comprised in an object attachable to a wrist is that then the distance between the accessory apparatus and the communication apparatus may be small whereby the signal attenuation may be small.

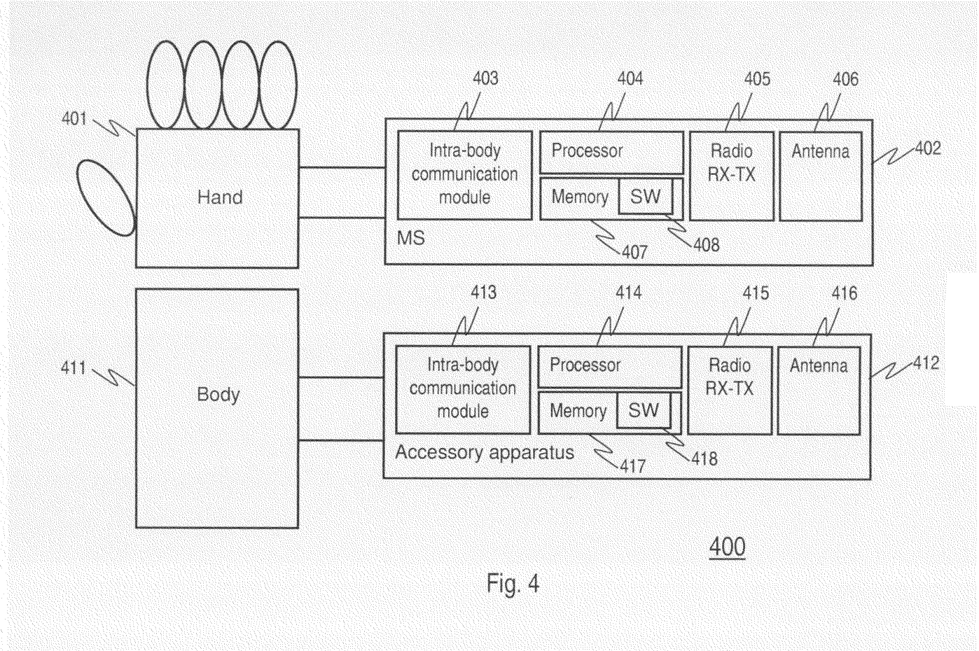

FIG. 4 shows a system 400 according to an embodiment of the invention. The system comprises a mobile station 402 and an accessory apparatus 412. (These may be for example the mobile station 302 and the accessory apparatus 303 of FIG. 3.) The mobile station 402 is in contact with a hand 401 of a user and the accessory apparatus 412 is in contact with some part of the body 411 of the user (e.g. wrist).

The mobile station comprises a processor 404 for controlling the mobile station, and a memory 407 comprising computer program code or software 408. The software 408 may include instructions for the processor 404 to control the mobile station 402 such as an operating system and different applications. Further the software 408 may comprise instructions for controlling the mobile station to provide the functionality of the invention. For connecting to a radio network the mobile station comprises a radio RX-TX block 405, which is a fully functional cellular phone transceiver including a radio frequency (RF) part and a base band part. The radio RX-TX part 405 is connected to an antenna 406, which provides air interface to a radio network. Further the mobile station comprises an intra-body communication module 403, which is arranged to provide data exchange be the mobile station and the accessory apparatus. The mobile station 402 would typically comprise also a user interface (not shown) for receiving user input and providing output to the user. In addition the mobile station 402 would typically comprise a battery (not shown) for providing power for different components of the mobile station.

The accessory apparatus comprises a processor 414 for controlling the accessory apparatus, and a memory 417 comprising computer program code or software 418. The software 418 may include instructions for the processor 414 to control the accessory apparatus 412 such as an operating system and different applications. Further the software 418 may comprise instructions for controlling the accessory apparatus to provide the functionality of the invention. For connecting to a radio network the accessory apparatus comprises a radio RX-TX block 415, which is a fully functional cellular phone transmitter, which includes an RF part and a base band part, but with regard to receiver functionality the radio RX-TX block 415 comprises only synchronization functions. (The accessory apparatus is not required to be able receive payload data, but this is not excluded either.) For example in a WCDMA system, the accessory apparatus may have the functionality for frame synchronization and chip synchronization. The mobile station 402 may then provide base station information (such as DL scrambling code etc . . . ) in order to help the accessory apparatus 412 to synchronize with a base station of the radio network.

The radio RX-TX part 415 is connected to an antenna 416, which provides air interface to a radio network. Further the accessory apparatus comprises an intra-body communication module 413, which is arranged to provide data exchange between the mobile station and the accessory apparatus. In addition the accessory apparatus 412 would typically comprise a battery (not shown) for providing power for different components of the accessory apparatus. A specific user interface is typically not included in the accessory apparatus, but it is not excluded either.

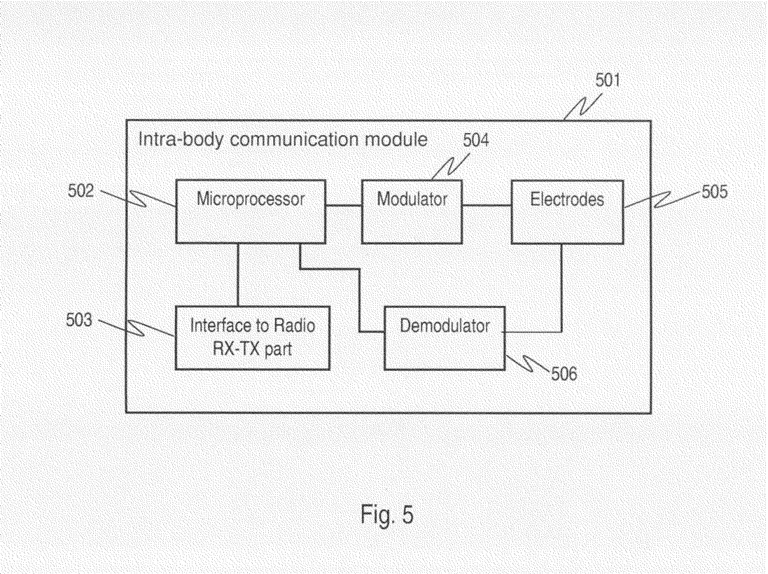

FIG. 5 shows a block diagram of an intra-body communication module 501 according to an embodiment of the invention. Such module may be located in a mobile station or in an accessory apparatus and it may be for example either one of the intra-body communication modules 403 and 413 of FIG. 4.

The intra-body communication module 501 comprises a modulator 504 and a demodulator 506 for modulating and demodulating intra-body communication signals. The modulator and demodulator are connected to electrodes 505, which provide connection to a human body. The electrodes 505 are shared by the modulator 504 and the demodulator 506 in time duplex mode. Further the intra-body communication module comprises an interface 503 to radio RX-TX part for enabling co-operation for example with radio RX-TX block 405 or 415 of FIG. 4. For controlling the intra-body communication module, it comprises a microprocessor 502.

The microprocessor 502 may be arranged to control the intra-body communication module to provide the functionality of the invention. The microprocessor may control the communication module to operate as a communication module 403 for the mobile station 402 of FIG. 4. In that case the communication module may be controlled to receive Tx data bits, Tx power, transmission time through the interface 503 and to send them out through the intra-body communication connection using the electrodes 505. Alternatively, the microprocessor may control the communication module to operate as a communication module 413 for the accessory apparatus 412 of FIG. 4. In that case the communication module may be controlled to receive Tx data bits, Tx power, transmission time through the intra-body communication connection using the electrodes 505 and send them out through the interface 503.

It should be appreciated that the microprocessor 502 and the processor 404 or 412 of FIG. 4 could be the same component. That is, the intra-body communication module does not necessarily require its own processing component.

Moreover it should be appreciated that the intra-body communication module 501 may comprise also memory (not shown) comprising computer program or software. The software may include instructions for the microprocessor 502 for controlling the intra-body communication module.

In an embodiment of the invention the (ESC) intra-body communication works at a data rate, which is substantially similar to the uplink data rate towards the radio network. If the uplink data rate is relatively low (i.e. it is not high), then also the intra-body communication data rate may be relatively low. For example for voice service, the uplink data rate may be 12.2 kbps, and the intra-body communication data rate may be around 20 kbps.

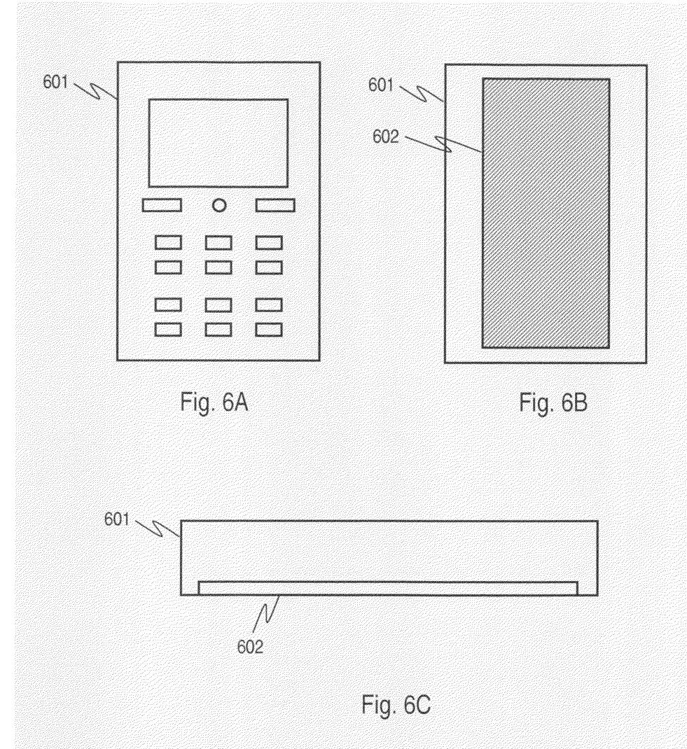

Since large size of an electrode/electrodes needed for intra-body communication has benefits both in Electro-Static Coupling and Electro-Static field generation, one option for implementing the electrodes is to integrate them with the shell of a mobile station. One electrode may be enough for the use of intra-body communication technology, but also more than one electrode may be used. FIGS. 6A-6C show a mobile station 601 with an example placement of an electrode according to an embodiment of the invention. The mobile station 601 comprises an electrode 602 attached to its back side for providing the intra-body communication capability. FIG. 6C shows a side view of the mobile phone with the electrode. By placing the electrode as shown in the FIGS. 6A-6C, connection to the human body is easily achieved when the user of the mobile phone is using the phone. Clearly also some other kind of placement of the electrode is also possible and as mentioned above, also more than one electrodes may be used; for example a two electrode implementation is possible.

In addition, the electrode/electrodes needed for intra-body communication may be implemented in a changeable functional cover of a communication apparatus or accessory apparatus. For example for a mobile station, one may buy functional covers comprising an electrode for intra-body communication and thereby have the intra-body communication capabilities for the mobile station. It should be appreciated that the cover may comprise also some other components needed for intra-body communication. For example some or all of the components of the intra-body communication module 501 of FIG. 5 may be incorporated in a cover.

It should be appreciated that placement of an electrode/electrodes in an accessory apparatus is similar to the placement in a mobile station. However, depending on the nature of the object in which the accessory apparatus is implemented, the placement of electrode(s) may be somewhat different.

FIG. 7 shows a messaging diagram according to an embodiment of the invention. Here an accessory apparatus is initially in sleep mode and waken up only when a connection between a mobile station and a radio network is activated. Additionally or alternatively the accessory apparatus may be waken up only when the mobile station is held by the user, i.e. only when the mobile station is in contact with a human body. Communication between the mobile station and the accessory apparatus is herein conducted via intra-body communication even though that may not be specifically stated in connection with each phase.

In phase 7-1 of FIG. 7 a call is initiated in the mobile station (either the user of the mobile station is initiating the call or the user of the mobile station answers an incoming call). It should be appreciated that instead of a call, which is used in this example, the connection between the mobile station and the radio network may alternatively be a data connection or connection relating to messaging (e.g. SMS or MMS).

In response to initiating the connection between the mobile station and the radio network the mobile station sends a wake up signal 7-2 to the accessory apparatus. Once the accessory apparatus has waken up in response to the wake up signal 7-2, it answers with a wake up response signal 7-3 to communicate to the mobile station that it is ready for operation. Then the mobile station sends base station information 7-4 to the accessory apparatus. In response to the base station information the accessory apparatus synchronizes 7-5 its radio interface with the base station and sends a synchronization successful signal 7-6 to the mobile station. Then the mobile station starts to employ the transmitter of the accessory apparatus for transmitting data to the radio network. The mobile station sends TX data and related TX information 7-7, 7-9 to the accessory apparatus and the accessory apparatus forwards the Tx data 7-8, 7-10 to the base station in the radio network. The related Tx information is information that the accessory apparatus needs for being able to maintain association to the radio network and thereby to send the Tx data. Depending on the implementation, the accessory apparatus may acknowledge success of data transmission to the mobile station (not shown in the FIG.). The sending of data may be repeated as many times as needed. Further it should be appreciated that the sending of TX information may be optional. For example if there are no changes in the TX information previously communicated, there is no need to resend the TX information with each portion of TX data.

After the phone call is terminated or data to be sent ends 7-11, the mobile station sends to the accessory apparatus a shut down signal 7-12. In response to the shut down signal the accessory apparatus goes to sleep mode 7-13. The accessory apparatus may also acknowledge the shut down signal to the mobile station (not shown). Additionally or alternatively the accessory apparatus may go to sleep mode also in case the intra-body connection to the mobile station is lost (for example because the mobile station lost connection to the body of the user) or if certain period of time has passed without receiving anything from the mobile station.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Furthermore, embodiments of the invention may be practiced in various components such as integrated circuit modules. The design of integrated circuits is a highly automated process. Complex and powerful software tools are available for converting a logic level design into a semiconductor circuit design ready to be etched and formed on a semiconductor substrate.

It should be appreciated that in this document, words comprise, include and contain are each used as open-ended expressions with no intended exclusivity.

The foregoing description has provided by way of non-limiting examples of particular implementations and embodiments of the invention a full and informative description of the best method and apparatus presently contemplated by the inventors for carrying out the invention. It is however clear to a person skilled in the art that the invention is not restricted to details of the embodiments presented above, but that it can be implemented in other embodiments using equivalent means without deviating from the characteristics of the invention. It should be appreciated that in any disclosed method the order of specific method steps is only illustrative and not restricted to the disclosed example. Thereby the order of the steps can be varied according to implementation needs.

Furthermore, some of the features of the above-disclosed embodiments of this invention could be used to advantage without the corresponding use of other features. As such, the foregoing description should be considered as merely illustrative of the principles of the present invention, and not in limitation thereof. The scope of the invention is only restricted by the appended patent claims.

1-40. (canceled)

41. A communication apparatus comprising
a memory,
a processor coupled to the memory,
a receiver capable of receiving data from a radio network, and
an intra-body communication block capable of communicating data through a human body, when in contact with the human body,
wherein the processor is configured to control the intra-body communication block to establish an intra-body communication connection with an accessory apparatus and to control the communication apparatus to communicate through the intra-body communication connection configuration data relating to connecting to the radio network.

42. A communication apparatus according to claim 41, wherein said processor is further configured to initiate an activation procedure through the intra-body communication connection for activating the accessory apparatus in response to activation of a radio connection between the communication apparatus and the radio network or in response to being in contact with a human body.

43. A communication apparatus according to claim 41, wherein said processor is further configured to control the communication apparatus to receive said configuration data, which is communicated through the intra-body communication connection, from the radio network via the receiver.

44. A communication apparatus according to claim 43, wherein said processor is further configured to control the communication apparatus to communicate configuration data through the intra-body communication connection in response to receiving said configuration data from the radio network via the receiver.

45. A communication apparatus according to claim 41, wherein the processor is configured to control the communication apparatus to transmit payload data to the radio network such that at least a portion of the payload data is communicated through said intra-body communication connection to said accessory apparatus for transmission to the radio network.

46. A communication apparatus according to claim 41, wherein the communication apparatus further comprises
a transmitter capable of transmitting data to the radio network, and wherein
the processor is configured to control the communication apparatus to transmit payload data to the radio network such that a first part of the payload data is communicated through said intra-body communication connection to said accessory apparatus for transmission to the radio network, and a second part of the payload data is transmitted to the radio network through said transmitter directly from the communication apparatus.

47. An accessory apparatus comprising
a memory,
a processor coupled to the memory,
a transmitter capable of transmitting data to a radio network, and
an intra-body communication block capable of communicating data through a human body, when in contact with the human body,
wherein the processor is configured to control the intra-body communication block to communicate over an intra-body communication connection with a communication apparatus, and to control the accessory apparatus to receive through the intra-body communication connection configuration data relating to connecting to the radio network via the transmitter.

48. An accessory apparatus according to claim 47, wherein said processor is further configured to receive an activation signal through the intra-body communication connection for activating the accessory apparatus and to activate the accessory apparatus in response to said activation signal.

49. An accessory apparatus according to claim 47, wherein the processor is further configured to control the accessory apparatus to transmit data to the radio network through the transmitter responsive to data communicated through the intra-body communication connection.

50. A method in a communication apparatus capable of communicating with a radio network and capable of communicating with an external apparatus over an intra-body communication connection, the method comprising:
establishing an intra-body communication connection with an accessory apparatus; and
communicating through the intra-body communication connection configuration data relating to connecting to the radio network.

51. A method according to claim 50, further comprising
initiating an activation procedure through the intra-body communication connection for activating the accessory apparatus in response to activation of a radio connection between the communication apparatus and the radio network, or in response to being in contact with a human body.

52. A method according to claim 50, further comprising
receiving said configuration data, which is communicated through the intra-body communication connection, from the radio network, and
communicating configuration data through the intra-body communication connection in response to receiving said configuration data from the radio network.

53. A method according to claim 50, further comprising
transmitting payload data to the radio network such that at least a portion of the payload data is communicated through said intra-body communication connection to said accessory apparatus for transmission to the radio network.

54. A method in an accessory apparatus capable of transmitting data to a radio network and capable of communicating with an external apparatus over an intra-body communication connection, the method comprising:
communicating over an intra-body communication connection with a communication apparatus; and
receiving through the intra-body communication connection configuration data relating to connecting to the radio network via the transmitter.

55. A method according to claim 54, further comprising
receiving an activation signal through the intra-body communication connection for activating the accessory apparatus; and
activating the accessory apparatus in response to said activation signal.

56. A method according to claim 54, further comprising
transmitting data to the radio network responsive to data communicated through the intra-body communication connection.

57. A computer program stored in a computer readable medium, the computer program comprising computer executable program code adapted to cause a communication apparatus capable of communicating with a radio network and capable of communicating with an external apparatus over an intra-body communication connection
to establish an intra-body communication connection with an accessory apparatus; and
to communicate through the intra-body communication connection configuration data relating to connecting to the radio network.

58. A computer program stored in a computer readable medium, the computer program comprising computer executable program code adapted to cause an accessory apparatus capable of transmitting data to a radio network and capable of communicating with an external apparatus over an intra-body communication connection
to communicate over an intra-body communication connection with a communication apparatus; and
to receive through the intra-body communication connection configuration data relating to connecting to the radio network via the transmitter.
